(19) United States
(12) Patent Application Publication
(10) Pub. No.: US 2008/0093477 A1
(43) Pub. Date: Apr. 24, 2008

(54) Working - Fluid Injector for a Piston Steam Engine

(76) Inventor: Andrzej Miczyk, Krakow (PL)

Correspondence Address: JOHN ALEXANDER GALBREATH, 2516 CHESTNUT WOODS CT, REISTERSTOWN, MD, 21136, US

(21) Appl. No.: 11/574,350

(22) PCT Filed: Sep. 12, 2005
(86) PCT No.: PCT/IB05/52967

§ 371 Date: Feb. 27, 2007

(30) Foreign Application Priority Data
Sep. 17, 2004 (PL) P-370154

(51) Int. Cl. B05B 1/30; F01K 21/02

(52) U.S. Cl. 239/91; 222/559

(57) ABSTRACT

An injector for injecting the working fluid of a piston vapour-engine. It incorporates an injector nozzle with injector nozzle-needle, needle actuating plunger and a solenoid controlled valve. It is characterised by the working fluid being supplied continuously to a working-fluid reservoir (4), while fluid for servocontrol purposes is supplied continuously to a servo-fluid reservoir (10). The injector nozzle-needle (1) is connected to the plunger (2) which passes through the working-fluid reservoir (4) and also through the servo-fluid reservoir (10). The top of the plunger (2) is capped by a plunger pressure-face (6), which is located in the servo-control chamber (11). The servo-control chamber (11) is connected by means of a feed-orifice (12) to the servo-fluid reservoir (10). The plunger (2) has a pressure-shoulder (7) located in the servo-fluid reservoir (10). The servo-control chamber (11) is connected by means of a bleed-orifice (15) to the bleed-valve (13), which releases the servo-fluid to the spill chamber (21).

### TECHNICAL FIELD

The invention is an injector for injecting a working fluid into a piston steam engine, intended particularly for high efficiency flash-steam piston engines. The task of the working-fluid injector is to inject, in one injection or a series of injections during each working cycle, a specified quantity of working fluid which has previously been pressurised to between 200-400 bar and heated to a temperature in the region 250-350 degrees Celsius into the engine's flash-chamber or directly into the working cylinder at the start of every working-stroke. These parameters may change according to the working fluid used. The working fluid is under a pressure, which is in excess of its vaporisation pressure, and therefore it remains in the liquid phase until it reaches the nozzle of the injector. The working fluid does not vaporise until the injector nozzle ejects it and its pressure falls. The working fluid may be water, alcohols, hydrocarbons, esters or mixtures of these mediums.

### BACKGROUND ART

Piston steam engines have a long history and many ideas have been put forward to improve them and increase their efficiency. One of these ideas proposes that the traditional method, where steam at high temperature and pressure is admitted directly into the working cylinder through an inlet valve operated by means of a crankshaft- actuated mechanical timing-gear, should be eliminated. Instead of this, hot water under high pressure is injected directly into the cylinder or into a heated pre-chamber (flash chamber), where it vaporises. Steam created by this means enters the cylinder where, through expansion, it carries out work on the piston of the engine. The idea of injecting hot water under pressure into a heated flash-chamber located immediately before the cylinder, where hot water is atomised and then heated further to reach a superheated state, is known from German patent No. 689961. In the description of this patent, water is pressurised by a feed-pump and delivered to a heat exchanger where it is heated initially. It is then pumped by a crankshaft-actuated mechanical injection pump to a second heat exchanger and delivered to an injection valve which is located in a flash-chamber situated before the working cylinder of the engine. A burner heats the flash-chamber, and combustion gases are utilised to heat feed-water in both heat exchangers. A similar solution for injecting water into a flash chamber located before the working cylinder of a piston steam engine is known from Swiss patent No. 243903. In this arrangement a pump, actuated mechanically from the engine's crankshaft, pressurises water and delivers it to a heat exchanger in which water is heated by the combustion gases of a burner (which has first been used to heat a flash-chamber) and then passes it to a mechanically actuated injector valve.

A complicated arrangement for a piston steam engine is known from German patent No. 828988. This, apart from the main engine, incorporates a secondary engine, which serves to drive feed-water pump, burner air fan, condenser fan, and also acts as a starter motor. The injection pump is powered mechanically from the main engine crankshaft and pressurises the feed-water supplying the injector valve which is located in the cylinder head of the main engine. Combustion gases from the burner using a liquid fuel heat the walls of the working cylinder of the main engine.

A similar arrangement is known from German Offenlegungsschrift No. 1909007. Another publication, PCT WO 98/55734 (DE 19723748.7) offers a solution for a piston steam engine specifically intended to power vehicles. This uses forced-feed circulation from a continuously working water feed-pump, which is connected to vaporisers, and super-heaters which individually surround opposed cylinders arranged symmetrically in a cylinder block. Burner feed air is also pre-heated by being passed through jackets surrounding the cylinders. The working medium is heated to super-critical temperature and pressure by continuously burning fuel or by drawing heat from a heat reservoir. The working medium is routed to the working cylinders by way of Electro-magnetic piston valves, which have no dead-space and after expansion in the cylinders, is exhausted through cylinder-wall ports. A spring closes the piston valves as soon as electric power is removed from the Electro-magnet, which controls them. This method allows for much better flexibility of operation of the injector valve in terms of start point and duration of opening. In this patent hot water under pressure is injected directly into the cylinder—not into a flash chamber. Also proposed in this patent is a method of operating the valve by pressurised water, which is not heated. This performs the function of cooling mechanical parts of the injector and ensures that seals function properly.

U.S. Pat. No. 4,426,847 (identical to German Offenlegungsschrift No. 3049024) describes a piston heat engine with external combustion in which energy is delivered to a working area by direct injection of liquid water at high temperature and high pressure into the cylinder of the engine. The water serves the role of a heat exchanger. Part of the water evaporates during injection and moves the piston. Liquid water is removed from the cylinder and returned to an external heat exchanger to be re-heated prior to injection again. All of the above mentioned arrangements concern piston engines working on the two-stroke principle in which the working fluid is generally hot water under high pressure which is injected directly into the working cylinder, or into a pre-chamber which is physically connected with the cylinder. In the cited patent texts it is either not stated how the injector works or the texts describe injectors which are mechanically actuated, mostly by a cam or crank arrangement affixed to the crankshaft. In such arrangements the injector pump causes an increase in water pressure immediately before the moment of injection, after which water pressure overcomes the resistance of a valve spring acting upon the nozzle- needle of the injector which then opens, allowing injection into the cylinder or pre-chamber to take place.

The above mentioned texts are characterised by several faults and imperfections which result in low thermal efficiency of the piston steam engine, this is caused mainly by the rigid mechanisms which connect the water injector with the crankshaft of the engine. This makes it difficult to vary duration of injection and the quantity of injected working-medium (water).

### DISCLOSURE OF INVENTION

According to the invention, the working-fluid injector is opened and closed by differential hydraulic pressure aided by spring pressure, in an arrangement where the differential hydraulic pressure is attained with the aid of a solenoid. This differs from the proposed unsatisfactory solutions in earlier patents, where closing and opening of the injector is affected directly—either mechanically or by Electro-magnetic actuator.

According to the invention the injector injects hot working fluid under pressure into a pre-chamber or flash-chamber and not directly into the cylinder. This is opposite to the described prior art where Electro-magnetically controlled injectors inject water directly into the cylinder.

The injector, according to the invention, additionally makes use of pressurised unheated servo-fluid in its operation. This is utilised to provide servo-power, to cool the solenoid, to cool the electric elements of the nozzle-needle position sensor and to provide thermal separation from the hot working-fluid reservoir. The essence of the invention is that the working-fluid injector of a piston steam engine which is intended particularly for high efficiency piston flash-steam engines incorporating an injector nozzle, an injector nozzle-needle, a plunger controlling the injector nozzle-needle and a solenoid controlling a valve is characterised by; working-fluid under high pressure and at high temperature being supplied continuously to a working-fluid reservoir whilst servo-fluid under high pressure is supplied continuously to a servo-fluid reservoir and an injector nozzle-needle which closes the nozzle is connected to a plunger which passes through the working-fluid reservoir and through a servo-fluid reservoir, where the top of the plunger forming a pressure face is located within a control chamber connected via a feed orifice to the servo-fluid reservoir. The plunger has a collar which forms a pressure shoulder located in the servo-fluid reservoir, while the control chamber is connected via a bleed-orifice with a bleed-valve which leads away servo-fluid to a spill-chamber which is connected to a spill connector.

The start and duration of injection of working-fluid into the flash-chamber or working cylinder of the engine is controlled by differential hydraulic pressure between the control chamber and the servo-fluid reservoir. The difference in hydraulic pressure between the control chamber and the servo-fluid reservoir is caused by opening or closing of the bleed-valve which connects the bleed-orifice with the spill chamber which is in turn connected to a spill connector which leads away servo-fluid to a supply tank. The bleed-valve connecting the bleed-orifice with the spill chamber is controlled by a solenoid.

The injector is fitted with a temperature and pressure sensor located in the working-fluid reservoir. The injector also has an injector nozzle-needle position sensor.

The injector nozzle-needle position sensor is located in the servo-fluid reservoir. Outputs from the temperature, pressure and nozzle-needle position sensors are carried to an electronic control unit (ECU) which controls the operation of the engine. The ECU sends control signals to the solenoid. The ECU controls the moment of opening of the injector or series of openings in a range from 20 degrees before top dead centre (TDC) of the working piston of the engine to 10 degrees after top dead centre (TDC) of the working piston of the engine. The ECU controls the duration of injection or series of injections in the range from 0 degrees to 160 degrees of crankshaft angular displacement. The plunger of the injector is sealed in the body of the injector by a working-fluid seal located in the central part of the body of the injector below the servo-fluid reservoir. The plunger of the injector is also sealed in the body of the injector by a servo-fluid seal located in the upper part of the body of the injector between the top of the plunger of the injector and the upper body of the injector.

### BRIEF DESCRIPTION OF DRAWINGS

The injector of the working-fluid of the piston steam engine according to the invention is represented in its best form in the attached drawing, in which

FIG. 1 represents the injector in sectional schematic form and

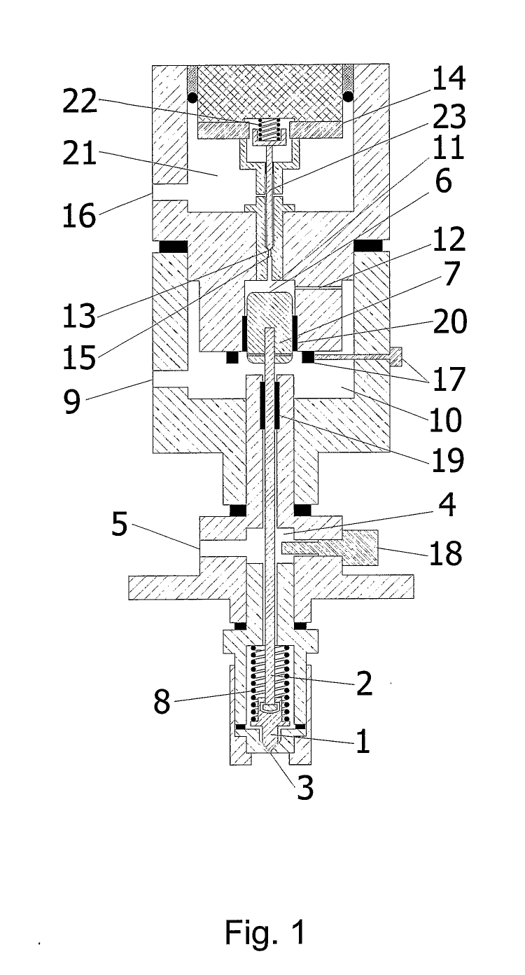

FIG. 2 represents a timing diagram showing start and duration of injection of working-fluid, in this case hot water, into the flash-chamber.

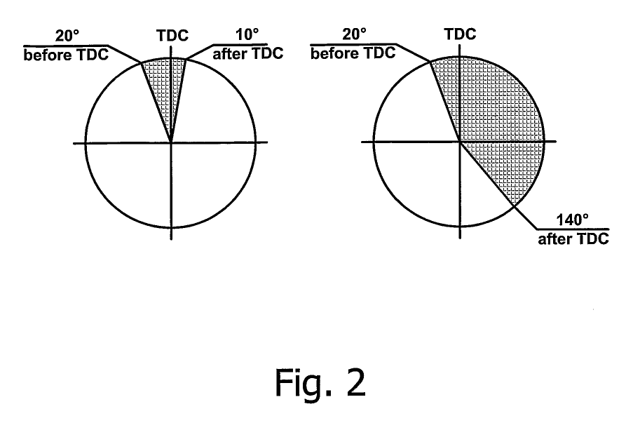

### BEST MODE FOR CARRYING OUT THE INVENTION

The injector, according to the invention, incorporates in its lower part a nozzle 3 and an injector nozzle-needle 1, which is sealed against the seat of the injector nozzle 3 by a plunger spring 8. The injector nozzle-needle is connected to the plunger 2 by means of a special knuckle joint, which allows for small misalignments of the injector nozzle-needle 1 and plunger 2 caused by thermal expansion of the hot materials during operation. The plunger 2 of the injector located in the injector body passes through the hot water (working-fluid) reservoir 4, the upper part of the injector body in which it is sealed by hot water seal 19 and also through the cold water (servo-fluid) reservoir 10. At its top end, the plunger 2 is capped by a pressure-face 6 whilst below the pressure-face 6 the plunger has a collar 7 forming a pressure-shoulder located within the cold water reservoir 10. The cold water reservoir 10 is connected to the control chamber 11 of the servo-system by means of a calibrated feed-orifice 12 located above the plunger pressure-face 6 of the control chamber 11. The control chamber 11 is connected at the top of the injector by a calibrated bleed-orifice 15 with a bleed-valve 13 the needle of which is controlled by a solenoid 14. The outflow of the bleed-valve 13 spills into the spill-chamber 21 connected by spill-connector 16, which returns used servo spill-water to a cold water tank. Temperature and pressure sensors 18 are located in the hot water reservoir 4 and these continuously monitor temperature and pressure in the hot water reservoir. A nozzle-needle 1 position-sensor 17 is located in the cold water reservoir 10. The nozzle-needle position-sensor 17 comprises a permanently fixed coil and an armature fixed to the plunger 2. Movements of the plunger 2 are detected as changes in magnetic field in the coil 17 of the sensor. Outputs from the temperature and pressure sensors 18 and the position sensor 17 of the injector nozzle-needle 1 are sent to an electronic control unit (ECU) with the objective of optimising the operation of the engine.

Hot water under pressure continuously supplies the hot water reservoir 4 through connection 5 with the objective of replacing injected water and maintaining pressure within the reservoir at a level sufficient to prevent vaporisation of the water.

Axial movements of the plunger 2 and the nozzle needle 1 of the injector are induced by means of differential hydraulic pressure acting on the plunger pressure face 6 of the plunger 2 and on the pressure shoulder 7 of the plunger 2 in combination with spring pressure of the plunger spring 8. The servomechanism by which this takes place comprises of cold pressurised water connector 9, which supplies the cold water (servo-fluid) reservoir 10. The cold water reservoir 10 feeds the control chamber 11 of the servomechanism through the feed-orifice 12. When the bleed-valve 13, controlled by the solenoid 14 is closed, pressure in the control chamber 11 of the servo mechanism is close to or equal to the pressure in the cold water reservoir 10 and the pressure on the pressure-face 6 of the plunger 2 is equal to the pressure on the pressure-shoulder 7 of the plunger 2. When the bleed-valve 13 is open, the control chamber 11 of the servomechanism releases water through the bleed-orifice 15.

The feed-orifice 12, as well as the bleed orifice 15, are so calibrated that the outflow of cold water through the bleed-orifice 15, is greater than the inflow of water through the feed-orifice 12. This is the reason for the fall in water pressure in the control chamber 11 of the servo mechanism, and this in turn lowers the pressure on the pressure face 6 of the plunger 2 which causes the movement of the plunger 2 together with the nozzle-needle 1 of the nozzle 3 of the injector and the opening of the nozzle 3 of the injector. Each time the nozzle 3 is opened a metered quantity of pressurised water is released from the hot water reservoir 4 and this water is injected into the flash-chamber or directly into the working cylinder in the form of highly atomised droplets. Water released through the bleed-valve 13 is led away to a cold water tank by means of the spill connector 16.

The start point of injection or series of injections is measured in relation to the top dead centre (TDC) of the piston and may vary between 20 degrees before top dead centre (TDC) to 10 degrees after top dead centre (TDC). The duration of injection or series of injections is measured in degrees of crankshaft angular displacement and may vary between 0 degrees to a maximum of 160 degrees. The actual start point and duration change in accordance with power demand and torque requirements of the engine.

The injector is fitted with temperature and pressure sensors 18, which continuously monitor conditions in the hot water reservoir 4, and also a nozzle-needle 1 position-sensor 17 which comprises a fixed stationary coil and an armature fixed to the plunger 2. Movements of the plunger are, by this means, detected as changes in magnetic field in the coil of the sensor 17. Outputs of these sensors are fed to the electronic control unit (ECU) in order to optimise the operation of the engine.

The plunger 2, connected to the nozzle-needle 1 of the nozzle 3 of the injector passes through three sectors of the injector: hot water reservoir 4, cold water reservoir 10 and the control chamber 11 of the servo mechanism. The hot water seal 19 and cold water seal 20 provide effective isolation between these three sectors.

The flow of cold water, apart from supplying the servomechanism also protects the hot water seal 19 from high temperatures in the adjacent hot water reservoir 4. This is achieved by appropriate location of the seal 19. The cold water also acts as a cooling medium for the electrical elements (needle position sensor coil 17 and also the solenoid 14 located in the injector and protects them from the hot external elements which surround the injector.

The operation of the injector may be divided into five phases:

1. Engine not operating—injector is closed: since the engine is not operating, the water pump is not operating and therefore no hydraulic pressure exists within the system. The only pressure source operating on elements of the injector is the pressure of the plunger spring 8 and the pressure of the solenoid spring 22.

2. Engine operating—injector is closed: since the engine is operating, the water pump is supplying hot pressurised water to the hot water reservoir 4 and pressurised cold water to the cold water reservoir 10. The solenoid is not activated, therefore the bleed valve 13 closes off the bleed orifice 15. At this time the pressure in the servo control chamber 11 is close to equal the pressure in the cold water reservoir 10. Pressure exerted on the pressure-face 6 of the plunger 2, together with the pressure exerted by the plunger spring 8 on the plunger 2 overcomes the pressure exerted on the pressure-shoulder 7 and keeps the nozzle 3 closed. Nozzle 3 therefore remains closed.

3. Engine operating—injector opening—start of injection: the solenoid 14 is supplied with high initial current from the electronic control unit (ECU), which ensures that the force developed by the solenoid 14 overcomes the force of the solenoid spring 22 and the bleed valve opens immediately. The high initial current is reduced almost immediately to a level sufficient for the solenoid 14 to hold the armature. Such a reduction in current is made possible by the fact that after activation, the solenoid's magnetic air-gap is considerably smaller. When the bleed-orifice 15 is open, cold water flows from the control chamber 11 via the bleed-valve into the overspill chamber 21 and from there via the spill connector 16 to return to the water (servo-fluid) tank. The opening of the bleed-orifice 15 causes the pressure in the servo control chamber 11 to fall below the pressure exerted on the pressure-shoulder 7 of the plunger 2. The differential pressure between the pressure-face 6 of the plunger 2 and the pressure-shoulder 7 of the plunger 2 is sufficient to overcome the pressure exerted by the plunger spring 8 of the plunger 2. Injector nozzle-needle 1 of the nozzle 3 opens and injection of hot water into the working cylinder or flash chamber begins.

4. Engine operating—injector is fully open: Speed of opening of the injector nozzle 3 is controlled by the difference between the flows through the bleed orifice 15 and the feed-orifice 12. The plunger 2 of the injector moves upwards until stopped by a cushion of water, which is, formed by the flow between the bleed-orifice 15 and the feed-orifice 12. The nozzle 3 of the injector is now completely opened and hot water is injected into the flash-chamber or working cylinder at a pressure close to the pressure in the hot water reservoir 4 and in the hot water supply system.

5. Engine operating—injector closed—end of injection: As soon as electric current ceases to flow through the solenoid 14, the solenoid spring 22 causes the bleed valve nozzle-needle 23 of the bleed-valve 13 to move downwards, the bleed-valve 13 closes the bleed-orifice 15. The closing of the bleed-orifice 15 causes an increase in pressure in the servo-control chamber 11 resulting from an inflow of water from the cold water reservoir 10 via the feed-orifice 12. When the pressure in the servo control chamber 11 again rises to a level sufficient to overcome the sum total of the opposing forces acting on plunger 2 (from plunger spring 8 of plunger 2 and hydraulic pressure acting on the pressure shoulder 7 of plunger 2), the injector nozzle-needle 1 of the nozzle 3 of the injector closes and injection ends.

### INDUSTRIAL APPLICABILITY

The injector of working-fluid for piston steam engines, according to the invention, has industrial applications in external combustion piston steam engines—in particular in piston steam engines intended for powering land vehicles, marine vessels and aircraft, as well as piston steam engines intended to power machines—self-powered, portable and stationary.

1. An injector for the working-fluid of a piston vapour-engine, intended particularly for high efficiency flash-steam piston engines incorporating an injector nozzle with injector nozzle-needle, plunger controlling the nozzle-needle and a solenoid controlling a valve, said is characterised by: working-fluid under high pressure and at a high temperature being supplied in a continuous manner to a working-fluid reservoir (4) while servo-fluid is supplied in a continuous manner to servo-fluid reservoir (10), while injector nozzle-needle (1) closes nozzle (3) of the injector is connected with a plunger (2) which passes through working-fluid reservoir (4) as well as servo-fluid reservoir (10) and is capped by a pressure-face (6) located in servo-control chamber (11) which is connected by a feed-orifice (12) to servo-fluid reservoir (10), also the plunger (2) has a pressure-shoulder (7) located in the servo-fluid reservoir (10) and the servo-control chamber (11) is connected by a bleed-orifice (15) to bleed-valve (13) which leads away servo-fluid to spill-chamber (21) connected to servo-fluid spill connector.

2. An injector according to claim 1 in which the start of injection of working fluid into the flash-chamber or working-cylinder is initiated by the difference in hydraulic pressure between the servo control chamber (11) and that in the servo-fluid reservoir (10).

3. Injector according to claim 2 in which the difference in hydraulic pressure between the servo control chamber (11) and servo-fluid reservoir (10) is caused by the closing or opening of a bleed-valve (13) which connects the bleed-orifice (15) with the spill chamber (21) connected by spill connector (16) to the servo-fluid tank (not shown).

4. Injector according to claim 2 or claim 3 where bleed-valve (13), connects bleed orifice (15) with spill chamber (21) via bleed valve nozzle-needle (23) of the bleed valve (13) which is controlled by solenoid (14),

5. Injector according to claims 1 or 2 or 3 or 4 characterised by having temperature and pressure sensors (18) located in the working-fluid reservoir (4).

6. Injector according to claims 1 or 2 or 3 or 4 characterised by having a position sensor (17) for the injector nozzle-needle (1).

7. Injector according to claim 6 characterised by the position sensor (17) of the injector nozzle-needle (1) being located in the servo-fluid reservoir (10).

8. Injector according to claims 1 or 2 or 3 or 4 or 5 or 6 or 7 characterised by outputs from the temperature and pressure sensors (18) and injector nozzle-needle (1) position-sensor (17) being fed to an electronic control unit (ECU) which controls the operation of the engine.

9. Injector according to claim 8 characterised by the electronic control unit (ECU) sending control signals to the solenoid (14).

10. Injector according to claim 9 characterised by the electronic control unit (ECU) regulating the timing of start of injection or series of injections of working-fluid in the range 20 degrees before top dead centre (TDC) to 10 degrees after top dead centre (TDC) of the engine's working piston.

11. Injector according to claim 9 characterised by the electronic control unit (ECU) regulating the duration of injection or series of injections of working-fluid within the range 0 degrees to 160 degrees of crankshaft angular displacement.

12. Injector according to claim 1 characterised by the plunger (2) being sealed in the body of the injector by the working-fluid seal (19) located in the central part of the body of the injector below the servo-fluid reservoir (10).

13. Injector according to claim 1 characterised by the plunger (2) being sealed in the body of the injector by the servo-fluid seal (20) located in the upper part of the injector body between the upper part of the plunger (2) and the upper body of the injector.
